(19) United States
(12) Patent Application Publication
(10) Pub. No.: US 2017/0325120 A1
(43) Pub. Date: Nov. 9, 2017

(54) QUALITY OF EXPERIENCE ENFORCEMENT IN COMMUNICATIONS

(71) Applicant: NOKIA SOLUTIONS AND NETWORKS OY, Espoo (FI)

(72) Inventors: Peter SZILAGYI, Budapest (HU); Csaba VULKAN, Budapest (HU)

(21) Appl. No.: 15/533,820

(22) PCT Filed: Dec. 10, 2014
(86) PCT No.: PCT/EP2014/077146

§ 371 Date: Jun. 7, 2017

(51) Int. Cl. H04W 28/02; H04L 12/24; H04W 24/08

(52) U.S. Cl. CPC H04W 28/0268; H04W 24/08; H04L 41/5025; H04L 41/5067

(57) ABSTRACT

A network node, such as a quality of experience QoE orchestrator, start monitors (400) data traffic related to a terminal device, in order to detect (402) a data flow related to an application session. The network node derives (403) resource requirement information defining a required QoE level to be provided to the terminal device regarding the application session. The network node performs (404) QoE measurements to obtain information on QoE experienced by the terminal device regarding the application session. Based on the QoE measurements, the network node executes one or more actions in order to enforce (405) the quality of experience QoE of the application session to meet the resource requirement.

### TECHNICAL FIELD

The invention relates to communications.

### BACKGROUND

Quality of experience (QoE) is a measure of the overall value of a service provided from a user's perspective. QoE takes into consideration various factors that contribute to overall user value, such as suitableness, flexibility, mobility, security, cost, personalization and/or choice.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, the invention will be described in greater detail by means of preferred embodiments with reference to the accompanying drawings, in which

FIG. 1 illustrates a wireless communication system to which embodiments of the invention may be applied;

FIG. 2 is a signalling diagram of a procedure for central QoE orchestration according to an embodiment of the invention;

FIG. 3 illustrates deployment and interfaces for centralized QoE management and enforcement;

FIG. 4 illustrates a process for central QoE orchestration according to an embodiment of the invention;

FIG. 5 illustrates orchestration and harmonization of actions depending on congestion status;

FIG. 6 illustrates integration and logical interfacing of a central QoE orchestrator with another network node;

FIG. 7 illustrates flow/application specific operation;

FIG. 8 illustrates TCP optimization and overload management in combination with QoE enforcement;

FIG. 9 illustrates dynamic QoS management;

FIG. 10 illustrates TCP optimization;

FIG. 11 illustrates active mode traffic steering based on an RFSP index;

FIG. 12 illustrates orchestration and harmonization of actions;

FIG. 13 illustrates activation and deactivation of TCP overload management;

FIG. 14 illustrates harmonization with idle mode TS/Wi-Fi offload;

FIG. 15 illustrates logical integration of a third party entity with PCRF/PCEF for QoS/QoE management;

FIG. 16 illustrates a blocks diagram of an apparatus according to an embodiment of the invention;

FIG. 17 illustrates a blocks diagram of an apparatus according to an embodiment of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

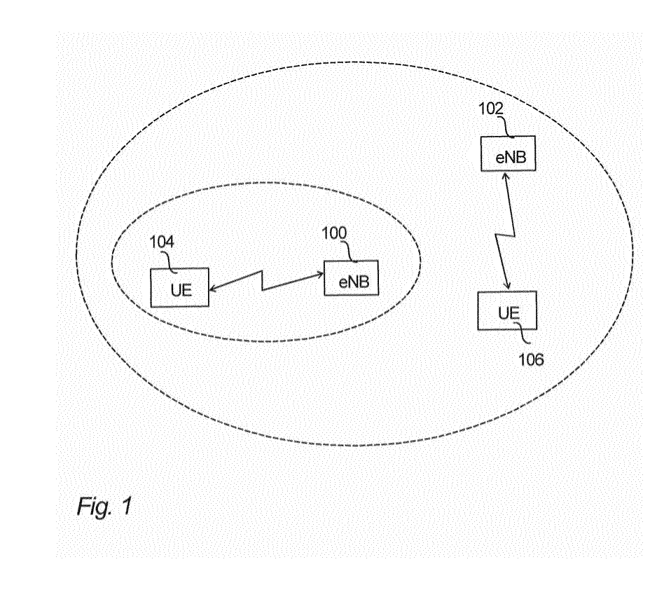

FIG. 1 illustrates a wireless communication scenario to which embodiments of the invention may be applied. Referring to FIG. 1, a cellular communication system may comprise a radio access network comprising base stations disposed to provide radio coverage in a determined geographical area. The base stations may comprise macro cell base stations (eNB) 102 arranged to provide terminal devices (UE) 106 with the radio coverage over a relatively large area spanning even over several square miles, for example. In densely populated hotspots where improved capacity is required, small area cell base stations (eNB) 100 may be deployed to provide terminal devices (UE) 104 with high data rate services. Such small area cell base stations may be called micro cell base stations, pico cell base stations, or femto cell base stations. The small area cell base stations typically have significantly smaller coverage area than the macro base stations 102. The cellular communication system may operate according to specifications of the 3^{rd} generation partnership project (3GPP) long-term evolution (LTE) advanced or its evolution version.

With increasing usage of internet-based, data driven over-the-top (OTT) applications (such as multimedia, social networking sites, e-commerce, web browsing, etc.) on mobile devices, mobile operators are trying to ensure good quality of experience (QoE) to users accessing native and OTT applications/services. Network side resources are not necessarily able to provide good QoE under any conditions including user mobility, application and traffic demand and network side congestion (regarding radio access and/or mobile backhaul). Under congestion, applications compete for the same resources. Thus in order to provide the best possible overall QoE, active traffic management and enforcement actions (e.g. bandwidth limitation, bearer prioritization, scheduling, etc.) are required. Accordingly, a network functionality is required for detecting and monitoring the applications and their QoE, for detecting and localizing congestion, for defining required actions that prevent/resolve degradation caused by inefficient resource allocation or congestion, and for enforcing/executing a selected action. In 3GPP mobile systems such as 3G, HSPA and/or LTE, policy and charging control (PCC) framework is a standardized solution for user or application differentiation and traffic management. However, the PCC framework (containing PCC/QoS rules governed by PCRF/PCEF) and the participating functionalities do not have the capability of managing QoE of the applications. The PCC framework does not directly define or manage how resources are allocated to the applications or bearers in case of congestion. The PCC rules are defined and enforced for each user/bearer/application/flow separately without considering that upon congestion the flows are competing for the same resources. This may lead to inefficient system utilization from customer satisfaction point of view where some applications are over-provisioned, using more resources than what is needed for good QoE, whereas others are under-allocated, receiving less than they need and having QoE degradations.

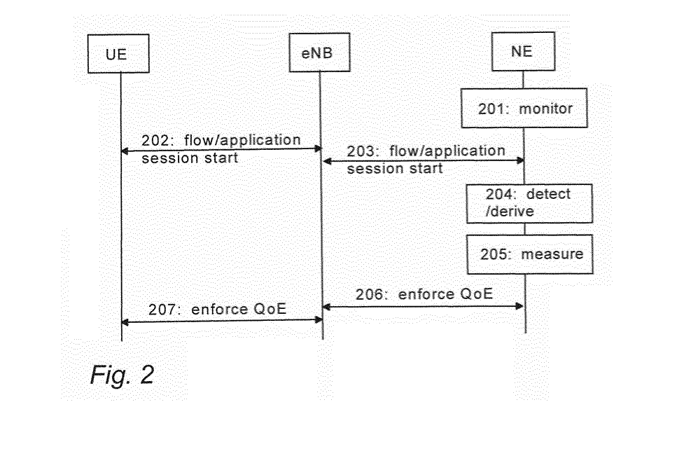

Let us now describe an embodiment of the invention for central QoE orchestration with reference to FIG. 2. FIG. 2 illustrates a signalling diagram illustrating a method for communicating QoE parameters between network elements of the cellular communication system. The network element may be a network node, an access node, a base station, a terminal device, a server computer or a host computer. For example, the server computer or the host computer may generate a virtual network through which the host computer communicates with the terminal device. In general, virtual networking may involve a process of combining hardware and software network resources and network functionality into a single, software-based administrative entity, a virtual network. In another embodiment, the network node may be a terminal device. Network virtualization may involve platform virtualization, often combined with resource virtualization. Network virtualization may be categorized as external virtual networking which combines many networks, or parts of networks, into the server computer or the host computer. External network virtualization is targeted to optimized network sharing. Another category is internal virtual networking which provides network-like functionality to the software containers on a single system. Virtual networking may also be used for testing the terminal device.

Referring to FIG. 2, in step 201, data traffic related to a terminal device UE is monitored by a network node NE such as a central QoE orchestrator. The central QoE orchestrator may be a separate entity (such as a QoS/QoE management entity QME) connected to the network, or the central QoE orchestrator may be integrated to another network node (such as PGW, PCEF and/or PCRF). In items 202, 203, an application session may be started for the terminal device, and a corresponding data flow may be transmitted within the application session in the system. If, based on the monitoring 201, the network node NE detects, in step 204, the data flow 202, 203 related to the application session, the network node derives 204 resource requirement information defining a required quality of experience QoE level to be provided to the terminal device regarding the application session. In step 205, the network node performs quality of experience QoE measurements to obtain information on quality of experience QoE experienced by the terminal device regarding the application session. In items 206, 207, based on the quality of experience QoE measurements, the network node executes one or more actions in order to enforce the quality of experience QoE of the application session to meet the resource requirement.

In an embodiment, the action to enforce QoE of the application session to meet the resource requirement, comprises a QoE management action such as a traffic management/QoE enforcement and/or a resource redistribution action.

In an embodiment, QoE management functionalities, their execution and orchestration are created and added to the system.

In an embodiment, an apparatus such as the central QoE orchestrator maintains correlated application information, QoE information and network status information for detecting QoE degradations, for detecting and localizing congestion, and for enforcing QoE of the applications. Multiple actions (such as traffic shaping, QCI/SPI modification, TCP optimization and overload management, traffic steering) may be triggered or controlled in order to change the way how the resources are redistributed, depending on what is supported by the system, whether there is congestion, and what is the congested resource. The central QoE orchestrator is able to operate multiple actions cooperatively towards the same goal, i.e. to provide good QoE for the applications. The central QoE orchestrator is also able to harmonize existing mechanisms so that they are not counteracting against QoE targets (i.e. the central QoE orchestrator is able to prevent existing network mechanisms from counteracting against the quality of experience QoE targets of the application session).

In an embodiment, holistic QoE management of native and OTT application sessions is performed. The QoE management includes real time QoE measurement, network status monitoring and context-based QoE enforcement via orchestrating and/or harmonizing end-to-end actions in the communications system.

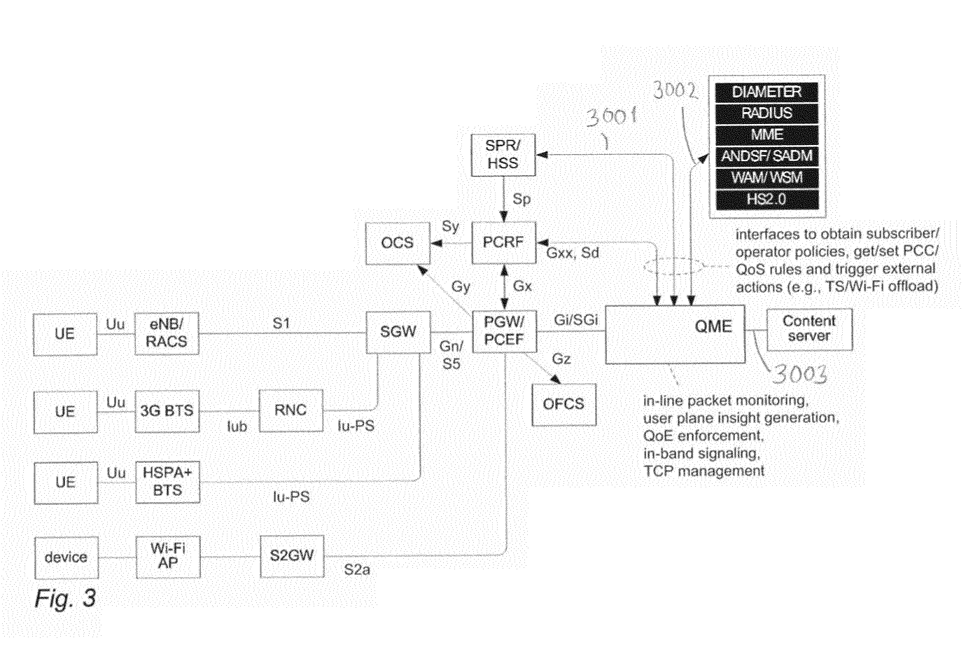

In an embodiment, an apparatus such as the central QoE orchestrator QME, is provided in the core network for QoE management (see FIG. 3). The central QoE orchestrator QME is capable of QoE management on an individual application session level (including native, i.e. operator services and OTT application sessions) and congestion control through a set of specialized actions that are selected based on the context and their applicability to a particular degradation type (e.g. QoE incidents, radio or transport congestion). The central QoE orchestrator QME uses its own mechanisms for the QoE management. However, if available, the central QoE orchestrator QME may also use existing system features for the QoE management. Therefore the central QoE orchestrator may include interfaces Gxx, Sd, Gi/SGi, 3001, 3002, 3003 for connecting to other network elements (such as SPR/HSS, PCRF, PGW/PCEF, content server, etc). The central QoE orchestrator QME may also collect additional insight and context information such as location data, subscriber/subscription/operator policies, PCC/QoS rules, etc.

An embodiment is applicable to the QoS/QoE management in various releases of 3GPP networks (including co-existence of multiple technologies). An embodiment is also applicable to non-3GPP access networks integrated via an access gateway (e.g. Wi-Fi via an S2a interface) into a 3GPP core network.

In an embodiment, the central QoE orchestrator performs real time holistic QoE management and enforcement for native and OTT applications in the communications system. The central QoE orchestrator may be deployed as an in-line, standalone entity within an LTE, WCDMA/HSPA(+), Wi-Fi and/or multi-RAT heterogeneous system. Alternatively an existing network element (such as PGW, PCEF and/or PCRF) may be configured to perform the central QoE orchestration functions. The central QoE orchestrator is able to maximize QoE and resource usage efficiency. Accordingly, the central QoE orchestrator monitors traffic to detect data flows and applications sessions, derives a resource requirement that guarantees the right level of QoE and performs QoE measurements to generate an insight to customer experience. Additionally, the central QoE orchestrator monitors the network status to create an up-to-date view on the status of the available network resources (transport and radio resources) to detect, if there is congestion in an end-to-end path, to localize it (e.g. identify and/or localize UE and the application session), and to detect the set of applications competing for the same resources. Depending on the network status, QoE, context of the applications/users and external input such as operator policies, the central QoE orchestrator may execute multiple actions to enforce QoE of the applications, i.e. manage the application traffic or QoS parameters of the bearers so that the QoE requirements of the application are met. Actions may be triggered within the central QoE orchestrator, such as traffic manipulation (e.g. shaping), or the central QoE orchestrator may trigger network side mechanisms via a standard interfaces. Multiple actions may be executed and orchestrated in parallel in order to provide good QoE for the applications. Existing network mechanisms that are not able to manage QoE, may also be harmonized with the QoE management, i.e. enabled/disabled by the central QoE orchestrator, so that they are not counteracting against the QoE targets.

The granularity of the QoE management and enforcement performed by the central QoE orchestrator may target individual application sessions (e.g. a specific video download) and/or aggregates of applications (e.g. calculating and enforcing a cumulative bandwidth for bulk downloads). Each application session may incorporate multiple data flows during its lifetime.

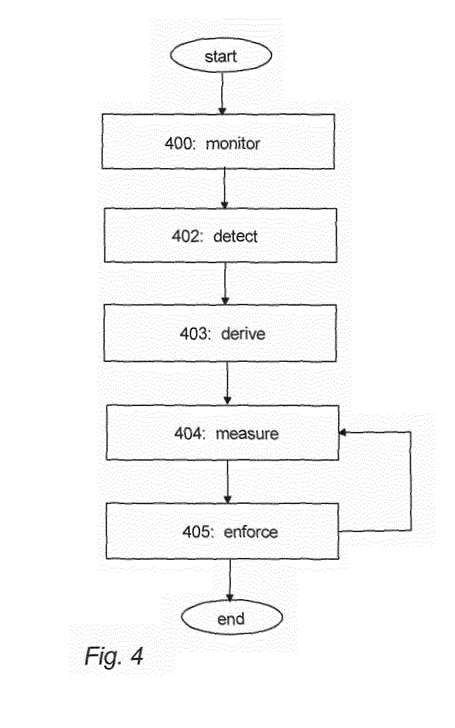

Let us now describe some embodiments with reference to FIG. 4. Referring to FIG. 4, in step 401, data traffic related to a terminal device UE is monitored by a network node such as a central QoE orchestrator. An application session may be started for the terminal device, and a corresponding data flow may be transmitted within the application session in the system. In step 402, the network node detects the data flow related to the application session. In step 403, the network node derives resource requirement information defining a required quality of experience QoE level to be provided to the terminal device regarding the application session. In step 404, the network node performs quality of experience QoE measurements to obtain information on quality of experience QoE experienced by the terminal device regarding the application session. In step 405, based on the measured quality of experience QoE, the network node executes one or more predefined actions in order to enforce the quality of experience QoE of the application session to meet the resource requirement. The central QoE orchestrator detects, identifies and localizes the flows corresponding to a given application session. The central QoE orchestrator defines the resource (e.g. bandwidth) requirements of the session based on the application type and demand (e.g. media rate or the amount of content to be requested). After an initialization phase (steps 401, 402, 403), QoE of the application session is managed (steps 404, 405) during the entire lifetime of the application session.

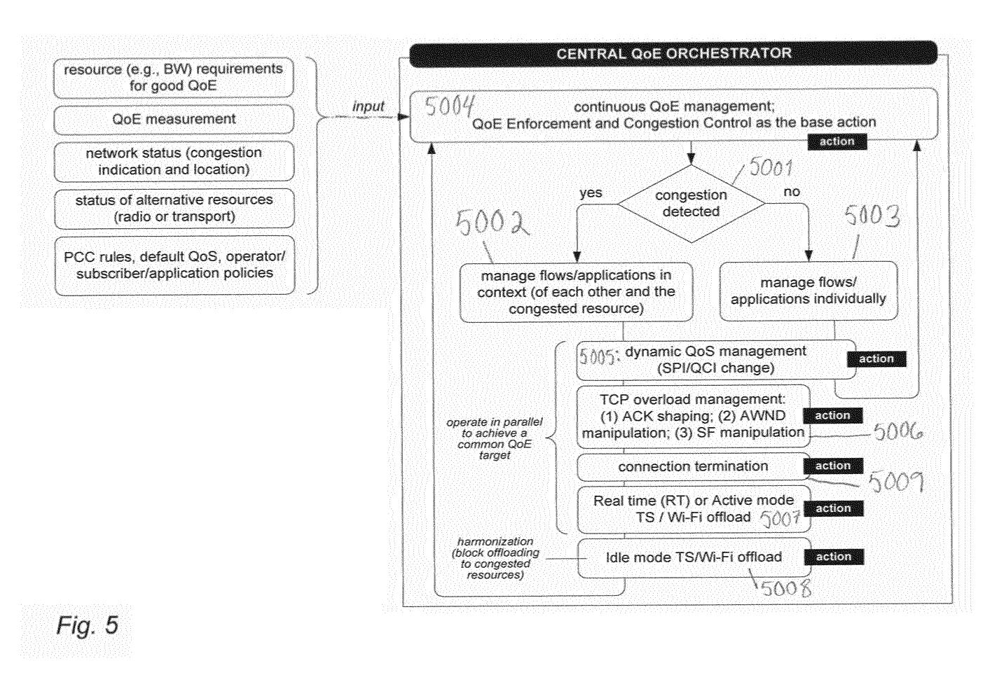

As illustrated in FIG. 5, the QoE management is a continuous process that enforces 5004 QoE of the application sessions. The QoE management considers the resources required for good QoE, the current QoE of the application, the network status and the available resources (including also alternative RATs or transport network segments that may be used to resolve the congestion), and PCC/QoS rules. QoE of the application sessions is measured via dedicated application specific indicators or KPIs (such as stalling for video downloads, overtime page download time for web browsing, etc.). The network status includes congestion detection, localization, and detecting and/or measuring the available resources. Alternative RATs, frequency layers and/or transport network resources are identified via topology database, network discovery and/or measurement reports. The PCC/QoS rules and other policies are considered as limits within which the QoE management has to operate, or as parameters that may be modified in order to improve QoE.

The operation of the central QoE orchestrator depends on whether congestion has been detected 5001 for a given resource (e.g. cell, transport link, etc.) or not. If there is no congestion, the central QoE orchestrator manages 5002 QoE of the application sessions sharing the resource on an individual basis, i.e. there is no need to consider the mutual influences between the application sessions as they are not competing for the same resources. In that case, the central QoE orchestrator harmonizes the QoS parameters (e.g. bearer attributes) and PCC rules applying to the application session to make sure that they do not limit QoE of the application. If there is congestion, the central QoE orchestrator identifies 5003 the application sessions competing for the same shared resources, considers their requirements and executes actions to redistribute the resources, such that QoE is preserved whereas scarce resources are not wasted.

The central QoE orchestrator performs QoE enforcement and congestion control for the QoE management, enforcing the limits on the resource usage of individual applications or groups of applications to prevent over-provisioning (in case there is no congestion) and redistributing the congested resources to prevent under-allocation (in case there is congestion).

The central QoE orchestrator performs dynamic QoS management 5005 by promoting or demoting the priority of the radio bearer (QCI in LTE and SPI in 3G/HSPA). In case there is congestion on the radio resources, the dynamic QoS management may be used to redistribute radio interface resources on the bearer level. If there is no congestion, the dynamic QoS management is used to change default QoS parameters if the default QoS parameters do not provide good QoE for the applications actually used. In case there are multiple applications simultaneously run on the same bearer, the dynamic QoS management is used in combination with the QoE enforcement.

The central QoE orchestrator performs TCP overload management 5006 by reducing the load that TCP sources may generate. The TCP overload management may include actions such as ACK shaping, advertised window (AWND) manipulation, and/or scaling factor (SF) manipulation. The TCP overload management is activated if light overload or increasing load trend is detected, in order to provide a proactive load throttling mechanism for reducing load.

The central QoE orchestrator performs TCP optimization by optimizing TCP throughput and sender behaviour such that TCP segment pacing is adjusted to a shaping rate defined by the QoE enforcement.

The central QoE orchestrator performs traffic steering/Wi-Fi offload by redirecting UEs to alternative radio layers or RATs in order to balance the load on radio resources or reduce the load on the transport network (in case the alternative radio resource applies disjoint transport). Real time traffic steering (TS) 5007 is executed during ongoing active connections and data transfer (requires MP-TCP support from UE). Active mode TS 5007 is executed when there is an idle period in the data transfer but the radio bearer is still established. Idle mode TS 5008 is executed when UE detaches from the cell. The real time TS and/or active mode TS may be used to manage QoE, while the idle mode TS is harmonized with the QoE management to prevent that new connections are steered towards already congested resources (e.g. a cell) as a result of the idle mode TS.

The central QoE orchestrator performs connection termination 5009. In case there is severe congestion where it is not possible to serve applications competing for the same resources according to the QoE requirements, some of the sessions are throttled or terminated from the network side to ensure that others may be served well with the existing resources. Criteria for the connection termination may be based on various inputs and policies (application type, operator policy, subscriber/subscription, etc.). The decision whether the applications are to be throttled or terminated depends on the QoE target of the application session.

Thus the central QoE orchestrator performs application session, network and user context based QoE management including real time QoE measurement, network status monitoring and QoE enforcement via orchestrating and/or harmonizing end-to-end actions in the system. The central QoE orchestrator is able to enforce QoE of multiple applications simultaneously sending traffic on the same bearer. The central QoE orchestrator enforces QoE in case of radio side congestion, transport network congestion as well as in case there is no congestion in the system. The central QoE orchestrator aligns multiple actions based on a common QoE target, which eliminates potential conflicts among the alternative actions, prevents that actions are counter-acting each other and enables them to be executed in parallel, increasing the efficiency of the QoE enforcement. The central QoE orchestrator harmonizes existing mechanisms (such as the idle mode traffic steering) that have no QoE awareness or target with real time QoE management.

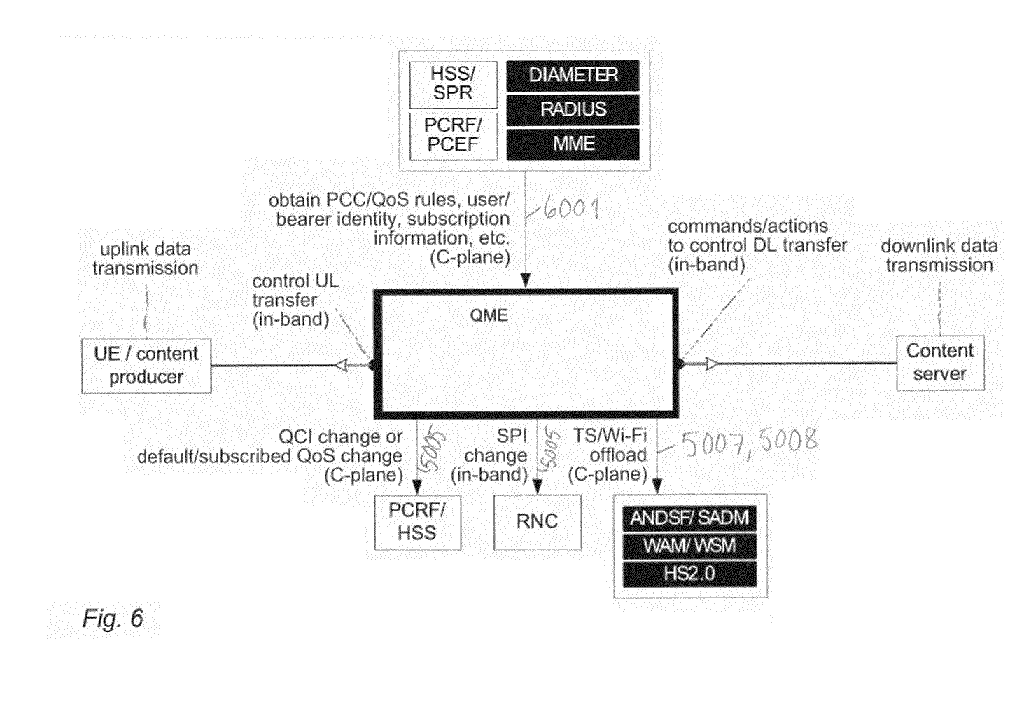

The central QoE orchestrator QME may be an entity running on or attached/integrated to an existing network element such as PGW, PCEF and/or PCRF, or it may be a standalone entity such as a QoS/QoE management entity QME. The central QoE orchestrator QME is provided with access to the user plane traffic at a network location where a high amount of sessions/connections/flows are aggregated, see FIG. 6 illustrating integration and/or logical interfacing of the central QoE orchestrator QME with another network node. This network location enables a QoE manager to collect a coherent and extensive view on the network status including the alternative radio layers and the transport infrastructure providing the connectivity between the core network and the individual radio heads, eNBs, BSs or APs. Additional interfaces 6001 with HSS/SPR, PCRF/PCEF (i.e. PCC) and MME using a diameter and/or RADIUS protocol are implemented to obtain insight to the PCC/QoS rules as well as to the user/bearer identity. This correlated insight enables the central QoE orchestrator QME to make accurate decisions about when and what action to trigger in order to enforce QoE of the application session while maintaining efficient system resource utilization. The QoE enforcement (possibly implemented via per application shapers) is continuously performed by the central QoE orchestrator QME in-line on the user plane traffic. Additional actions may be triggered on a need basis (e.g. increasing load, congestion, mismatch between the default QoS parameters and the application QoE requirements, etc.) in a harmonized way to contribute to the QoE enforcement. These actions may be triggered/executed using additional in-band or dedicated standard/proprietary control plane interfaces.

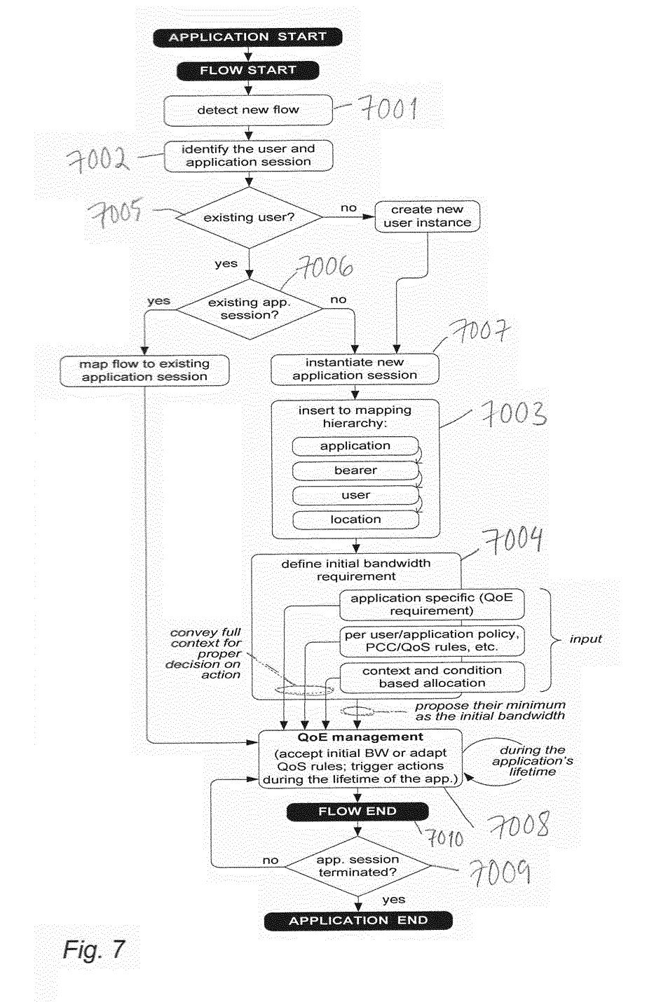

The central QoE orchestrator monitors user plane packets to detect new flows 7001 (e.g. TCP and UDP flows), and to identify 7005 the user and to identify 7006 the application session to which they belong, see FIG. 7 illustrating flow and/or application specific operation. New flows may be detected 7001 via explicit TCP-SYN connection establishment or recognizing partial flows, i.e. packets with address/port tuples not observed previously. The application session identity may be derived 7002 from application layer (e.g. HTTP) headers, known ports/addresses, marching DNS queries with the destination IP address or dissecting the SSL handshake in case of TLS security establishment. The identity of the user may be based on the IP address of UE or additional information such as IMSI, obtained from external interfaces such as RADIUS. Using the detected flow, user and application session identity, the central QoE orchestrator creates 7007 an association of the flows with the use and the application session and maintains a mapping 7003 of the application session to a given bearer and location. The bearer information may be derived from GTP-TEID and outer IP addresses in case user plane monitoring is performed on a GTP-based interface, or the information may be received in-band via header enrichment from a supporting entity or off-band from external interfaces. The location information may also be obtained via similar mechanisms.

For new application sessions, the central QoE orchestrator defines 7004 the initial resource (e.g. bandwidth) requirement based on individual needs of the application (e.g. the media rate of a video session, download rate to maintain a download time target for web pages, etc.), per user/application policies and PCC/QoS rules (if applicable), and the context and condition (such as network, resource and congestion status at the location of the user, other already established bearers and ongoing sessions, etc.). The lowest of these requirements is proposed as the initial BW requirement to the QoE management process that handles the application session and enforces its QoE during its lifetime. The full context of the initial bandwidth selection is also transferred to the QoE management to enable overriding the selection (in case the initial BW requirement is not enough for proper QoE due to the PCC rule or congested resource), deciding if the default QoS settings need to be adapted to the application itself, and performing additional actions if needed (such as handling multiple applications within the same bearer). During the lifetime of the application session, new connections may be established and dynamically added to the session as well as they may be completed and removed from the session. The localization of the user (and thus of the session) follows the handover of UE in real time, i.e. the location mapping is maintained up-to-date every time. The QoE management is performed until each flow corresponding to the application is terminated 7010 and the application session itself is also finished 7009.

Herein, QoE management refers any action that is executed for ensuring good QoE, preventing QoE degradation or resolving degradation for the application sessions. These actions include QCI/SPI change, QoE enforcement, real time/active mode TS/Wi-Fi offload, for example.

Herein, QoE enforcement refers to a specific QoE management action that is able to redistribute the resources according to the application needs without engaging in additional C-plane signaling (such as signaling needed for the QCI change). For example, a shaper hierarchy may be used for the QoE enforcement.

The QoE enforcement is a continuous activity of the central QoE orchestrator. The QoE enforcement may be implemented using shapers that operate on the cumulative traffic of the application session of the given user, or (alternatively) on a set of applications grouped based on arbitrary policies (e.g. each application of a given type such as peer-to-peer, etc.). The shapers enforce a maximum rate for the corresponding traffic by delaying excess data in their packet buffer, where the rate is defined based on the QoE requirement of the application (or applications) managed by the shaper. The shapers require a certain amount of buffer space to store packets that may arrive in burst or those that are not eligible for transmission (in case throttling is needed). The shapers may also have attributes such as the burst size and burst rate that enable a higher transmission rate up to a given amount of data size (i.e., the burst size). The shapers may be organized into a hierarchy so that the packets transferred from a shaper are enqueued to the buffer of another shaper to create hierarchical bandwidth distributions (possibly using a dynamic hierarchical token bucket structure). The shapers may also implement resource borrowing among each other (in order to implement a work conserving way of operation) so that bandwidth not utilized by one application may be transferred to another shaper, temporarily increasing its allowed rate for maximum system efficiency. In case there is no congestion in the system, the QoE enforcement follows the bandwidth requirement of the applications, so that they are not able to receive (significantly) more resources than what they need, preventing over-allocations and also preparing the configuration of the enforcement for congested cases. Additionally, for those applications that may benefit from increased bandwidth (e.g. file download or upload, web browsing) the QoE enforcement increases the bandwidth allocation to create reasonable load on the available resources, that is, in order not to waste any opportunity to transfer data. In case there is congestion, the central QoE orchestrator identifies the set of applications competing for the same resources and the amount of available resources. The central QoE orchestrator may construct a shaper hierarchy with a cumulative shaper representing the congested resource, configured with the amount of available resources as the shaper's rate, and channelize the shapers of the application sessions sharing the resource into the common shaper. This hierarchy may efficiently redistribute the bandwidth of the shared resource in a QoE friendly way, where resources not utilized by the application session may be borrowed by other application sessions to keep the system utilization at maximum. Shapers are not only used to throttle traffic (i.e. backpressure flows compared to their native sending rate) but also to prioritize flows/applications against others. Therefore, in case of congestion, some of the shapers scheduling data for the congested resource may even increase their rate to enforce QoE of the corresponding application sessions (whereas others are throttling non-interactive or bulk traffic). The shaping action maintains system efficiency (i.e. fully utilize the available resources) such that the maximum amount of application sessions (or, depending on operator policies, the important ones) are served with good QoE. This may require redistributing the available resources according to the QoE requirements of the application session. The available resources are detected by the central QoE orchestrator by correlating throughput measurements and congestion/overload detection, that is, the measured throughput on the congested/overloaded resource equals to the actual available capacity. In order to support the QoE enforcement, additional parallel actions are triggered (see the details of harmonization later), such as dynamic QoS management (in case of radio congestion) or even connection termination (in case the applications have conflicting requirements that cannot be satisfied at the same time).

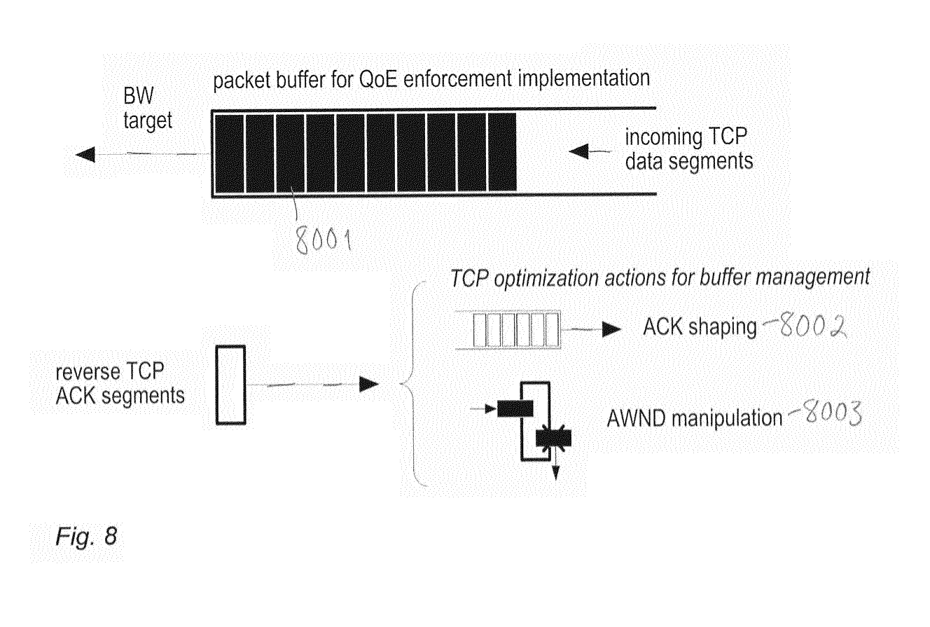

The QoE enforcement action cooperates with some of the TCP optimization and overload management actions to create a symbiotic interworking where buffer overflows in the shaper architecture are prevented via TCP ACK shaping or AWND manipulation. FIG. 8 illustrates the TCP optimization and overload management in combination with the QoE enforcement. ACK shaping 8002 delays acknowledgement segments towards TCP sources to lower the rate at which they are able to transmit new data segments. AWND manipulation 8003 overrides the native TCP flow control to limit the amount of data a sender is allowed to transmit. Without such actions, a potential buffer overflow causes tail drops that reduce the performance of the managed connections inconsistently due to triggering the multiplicative decrease end-to-end TCP congestion control. Instead, the buffers 8001 of the QoE enforcement infrastructure are continuously managed so that in case the target BW is enforced on a set of connections, the source of the traffic is also back-pressured smoothly (i.e. without discarding packets) to match its sending rate to the target BW as much as possible. This also prevents the central QoE orchestrator from becoming a heavy congestion point itself. Temporary differences in the target and actual rates or traffic bursts are still absorbed by the buffer. However, non-TCP traffic (e.g. peer-to-peer over UDP) may be subject to throttling according to the operator policies. If such traffic is detected, discard is a reasonable mechanism of traffic control. Other applications may provide real time streaming over RTP; for these, the manipulation of receiver reports in order to trigger TCP friendly rate control actions is used. Additionally, real time applications such as VoLTE and other native services carried over RTP/RTSP/RTCP are not to be subject to throttling, demotion or flow control/termination.

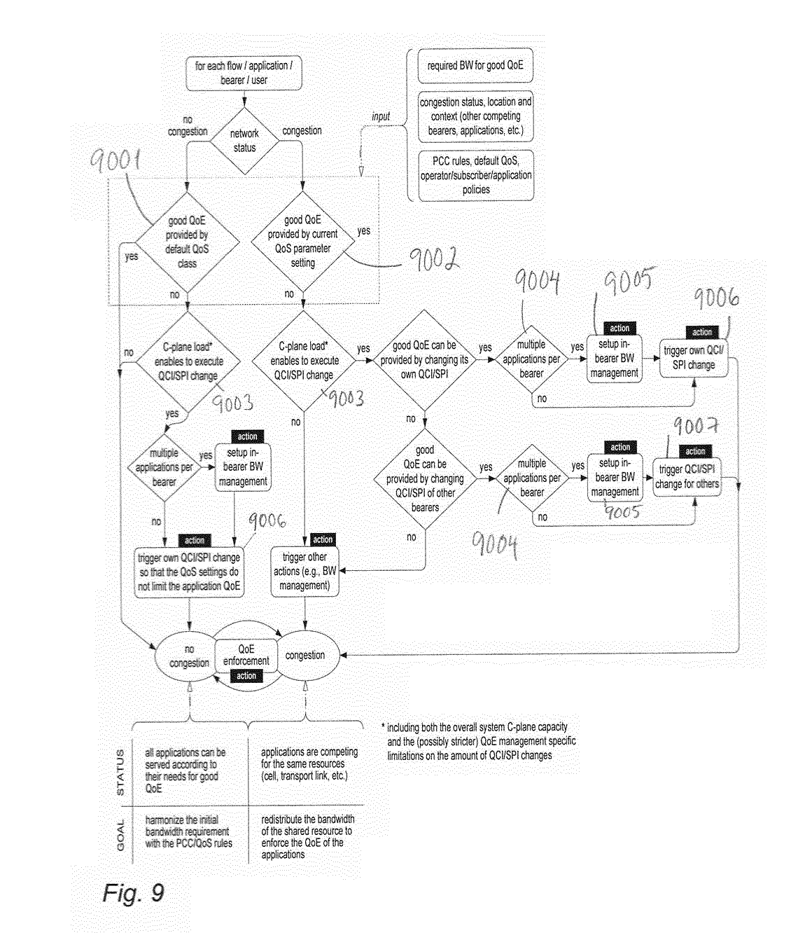

FIG. 9 illustrates dynamic QoS management, wherein the QCI/SPI change action is illustrated. QCI/SPI defines how a packet scheduler handles the bearer at eNB/BS and transport QoS class to which the bearer is mapped. Dynamic QoS management changes the priority (i.e. promotes or demotes the bearer) in real time. In case there is no congestion 9001, the central QoE orchestrator considers initiating the action to change the default QCI/SPI of the bearer in case it is not able to support the requirements of the application. In case there is congestion 9002 on the radio interface, the role of the action is to support a main QoE enforcement action in redistributing the resources according to the needs of the applications. The QCI/SPI change (promote) may involve the application/bearer where QoE degradation is detected/predicted 9006 or other applications/bearers changing (demote) 9007 their share from the radio resources. In 3G, the SRI change may be executed on top of an application aware RAN feature by changing DSCP markings of packets by the central QoE orchestrator, which is an in-band mechanism with no signalling overhead. In LTE, the QCI change is triggered through the standard bearer modification procedure. Due to the signalling overhead of the standard LTE implementation, the central QoE orchestrator considers the control plane capacity and load of the system to decide 9003 in case executing the QCI change fits into the signalling budget. Additionally, there may be individual central QoE orchestrator-specific limits on the amount of QCI/SPI modification (e.g. per second per BS/eNB) that are to be considered as well. The QCI changes are not to be initiated in bursts to protect control plane nodes from overload; instead, they are paced so that there are only a limited number of QCI change procedures under execution at a given time. As alternative QCI change implementations for LTE, the QCI may be changed via DSCP packet marking performed at the core and interpreted by eNB. Additionally, in case the QoE management entity is implemented in eNB itself or in RAGS properly integrated with eNB, the QoE management entity may internally influence the priority of the bearers without any additional communication.

As described above, the QCI/SPI change may be operated in parallel to a basic QoE enforcement action, i.e. it relies on the resource sharing of the radio packet scheduler in a complementary manner to the shaping performed by the central QoE orchestrator itself. Alternatively, to prevent too frequent QCI/SPI changes (i.e. to prevent control plane overload) the central QoE orchestrator may override the QoS profile of the users, natively (i.e. already during the initial attach) mapping each and every bearer (non GBR bearer) established to the internet APN to the same QCI/SPI class. This approach equalizes the priority of the bearers on the radio interface and relies on the QoE enforcement actions to handle QoE of the applications via shaping, eliminating the need for the dynamic QoS management. This may be a permanent rule or an adaptive one, e.g. applied only to a given resource or set of resources for which overload is detected. This measure is limited to newly established bearers, so there is a ramp up period until the dominant fraction of the bearers converge to the same QoS class. This eliminates the control plane overhead that the dynamic QoS management imposes on the affected elements. Alternatively, the same QCI/SPI may be used by default for every non-GBR bearer within the system and to achieve the QoS/QoE targets and enforce the PCC rules through the operation of the QoE management. This may even increase the efficiency of the QoE enforcement action in case it is performed in the core network as there is no additional resource sharing mechanism (the QCI based redistribution) to be considered (or even compensated) by the shapers.

As the QCI/SPI change only aligns how the resources are assigned to radio bearers on the air interface, in case there are multiple applications within the same bearer 9004, in-bearer shaping is to be performed 9005 by the QoE enforcement to decide how the bearer's resources are further shared by the applications. As the QCI/SPI effectively defines the resource sharing of the applications in case of radio congestion, this action is not necessarily usable for handling transport congestion.

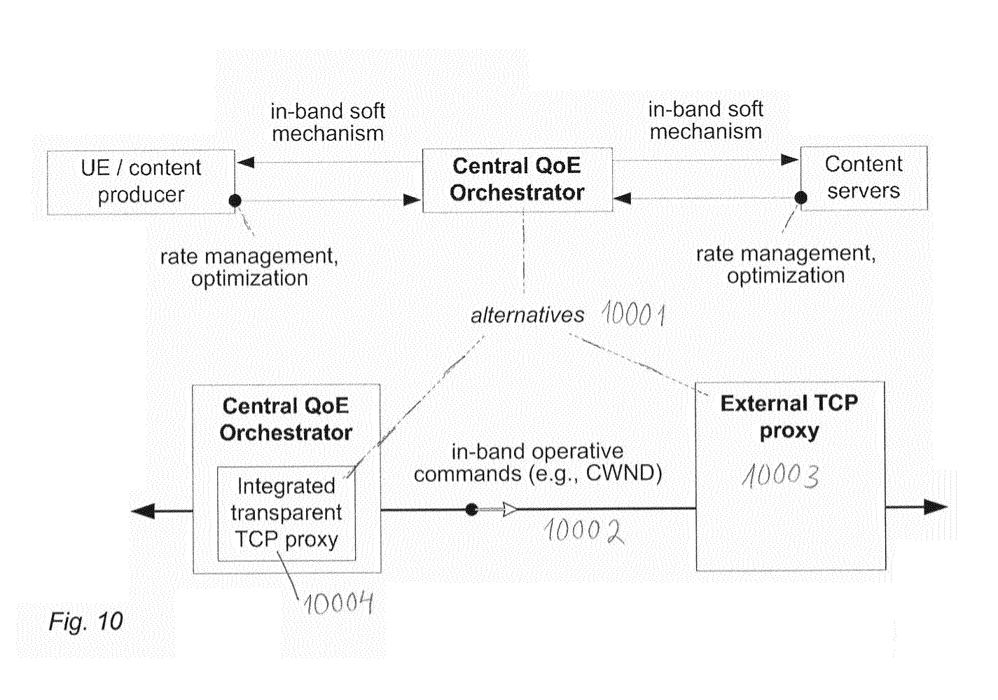

The TCP optimization may be executed without terminating the TCP connection (i.e. without the central QoE orchestrator beginning a TCP proxy). FIG. 10 illustrates TCP optimization alternatives 10001. The TCP optimization may be executed by the central QoE orchestrator QME as a transparent proxy 10004 that on-the-fly splits the end-to-end TCP connections and performs optimization as a TCP endpoint, or by outsourcing the TCP optimization to an external TCP proxy entity 10003 and commanding it via in-band signalling 10002.

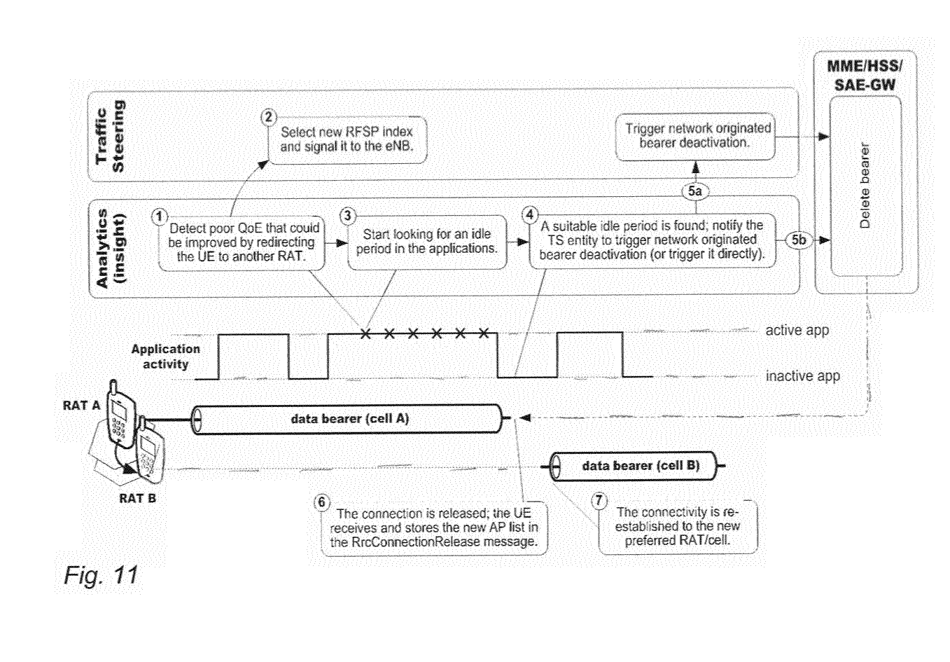

FIG. 11 illustrates active mode traffic steering based on an RFSP index. The active mode traffic steering may involve RFSP index signalling and network originated bearer deactivation 5a. The RFSP index defines the priority of the different RATs or frequency layers that UE is to consider when it establishes radio connectivity. The RFSP index is conveyed 2 to eNB and the corresponding priority list is signalled to UE when the radio bearer is deactivated. The proper schedule of the deactivation is based on a traffic analysis 1 and the detection 3, 4 of the next suitable idle period in the application traffic. The bearer is deactivated 6 from the network side (instead of relying on UE or the user to manually detach/loose connectivity and try to re-establish). As the bearer deactivation does not terminate the application itself, next time it needs to access the network, UE reestablishes 7 connectivity according to the priority list received during the detach.

The connection termination action involves discarding each packet in a given flow and/or sending a TCP RST packet in both directions (for TCP connections).

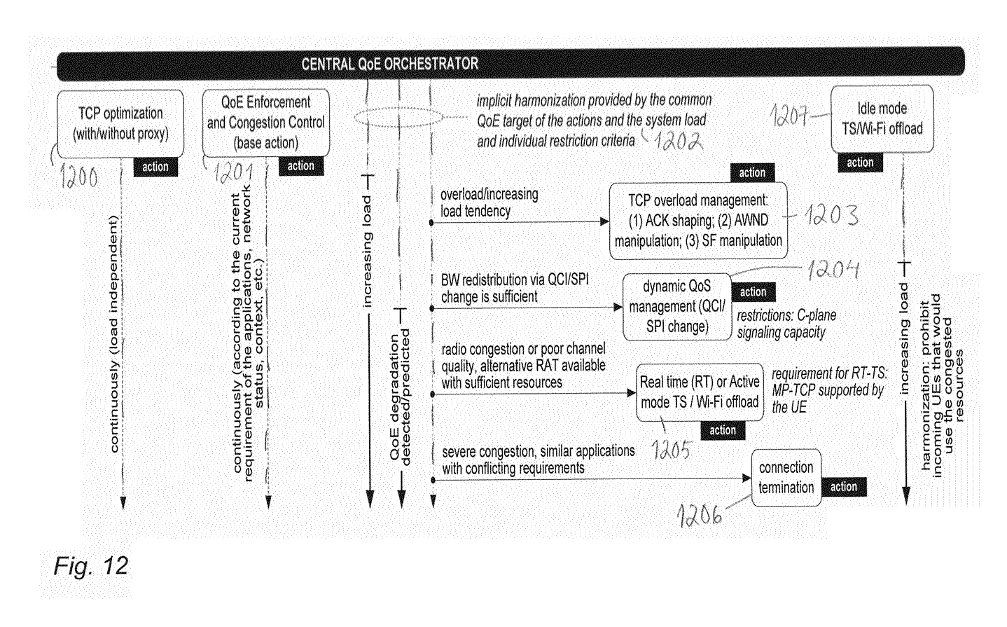

The central QoE orchestrator performs orchestration and harmonization of actions as illustrated in FIG. 12. There are actions that may be performed continuously, such as the QoE enforcement that continuously follows the flows and application sessions to maintain the corresponding shapers. The TCP optimization actions (with or without proxy) 1200 also cooperate with the QoE enforcement action 1201 in seamlessly managing the buffers of the enforcement infrastructure and actually enhancing the TCP operation regardless of the status of the network. The additional actions are triggered on a need basis, depending on the system load (i.e. level of congestion or trend of the load) as well as the QoE of the application sessions. The load based initiation and common QoE target create an implicit harmonization 1202 among the alternative actions and thus may be triggered and executed in parallel.

In response to the load increasing, soft load prevention mechanisms referred to as the TCP overload management actions are activated. The trigger of this action is the detection of overload by the central QoE orchestrator over a given shared resource. These actions target only those flows that are not sensitive of reduced throughput or that belong to applications that are served with low priority or with best effort. In each case, the actions themselves are executed on the targeted flows individually. Similarly to the TCP optimization actions, the soft overload prevention mechanisms also utilize the native TCP mechanisms to implement network insight assisted TCP operation. The ACK shaping and AWND manipulation 1203 may also be triggered as mechanisms to selectively reduce the rate of certain flows thus freeing resources that may be scheduled for other flows/application sessions or resolving congestion altogether. The SF manipulation 1203 is a complementary lightweight overload management action that removes the window scaling factor present in the SYN/SYN-ACK segments in case window scaling is negotiated during the TCP handshake. As a result, the TCP source and receiver both infer that the peer entity is not capable (or willing) to handle window scaling as such and they use the legacy advertised window size with 64 KB upper limit. The SF action is extremely lightweight as it only needs to act on the initial handshake packets and does not need to follow the connection afterwards.

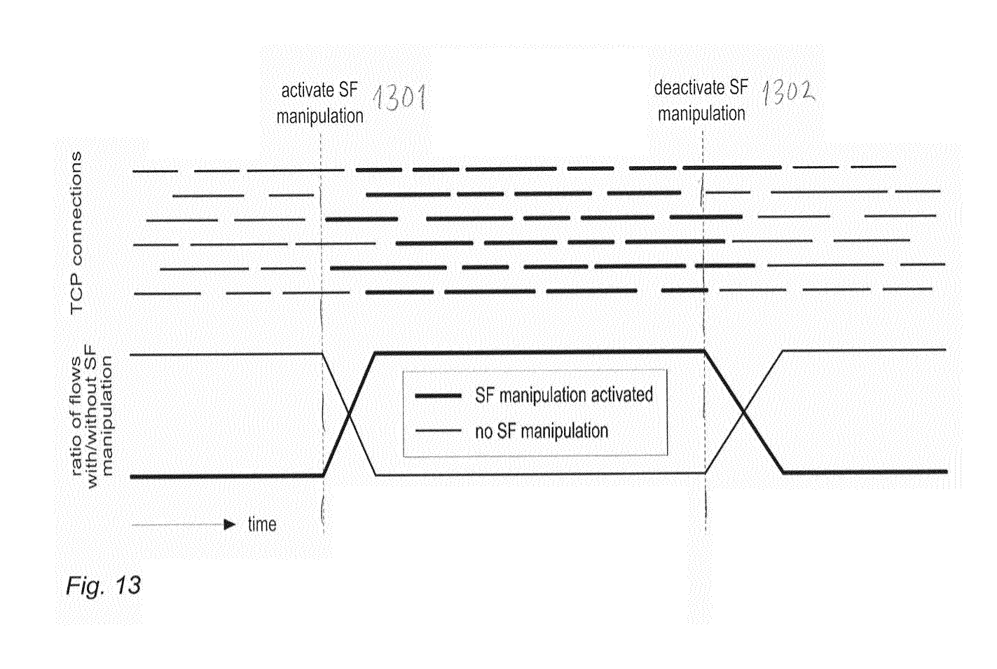

The TCP overload management actions may be switched on depending on the load and applied selectively to new flows (this is required for the SF manipulation but may apply to the AWND management or ACK shaping as well). As existing flows are terminated and new ones are established, the flow population gradually becomes subject to the overload management action. FIG. 13 illustrates activation 1301 and deactivation 1302 of the TCP overload management actions. Phasing out the action in case the load decreases follows the same logic where new flows are bypassing the overload management action, finally replacing each managed flow.

The TCP overload management actions interoperate natively with the QoE enforcement actions and may be triggered simultaneously with the dynamic QoS management 1204 as well but not each time for the same flows. Triggering the actions for flows that may become subject to an TS/Wi-Fi offload action 1205 is possible but not efficient as the flows may be terminated 1206 and re-established after the TS/Wi-Fi offload completes (as the device may even receive a new IP address).

The orchestration of the dynamic QoS management may be triggered to influence the share of the radio resources among bearers in case there is radio side congestion. The action is applicable, for example, in case of overload or light congestion when there are enough resources on the radio interface but the default bearer configuration causes QoE degradation. In these cases reconfiguring only a few bearers may solve or prevent the QoE degradations. This mechanism is an auxiliary tool of the QoE management that may be triggered simultaneously with the following other actions: QoE enforcement (yes), TCP overload management and TCP optimization (no, that is, connections subject of QoS management actions leading to their positive discrimination are not to be subject to TCP overload management; if resolving the congestion requires that the rate of these flows is reduced, TCP optimisation may be used as the auxiliary mechanism of a demotion). Triggering the action implies that QoE of the application may be enforced within the current cell/RAT context, thus making the corresponding UE/bearer subject to TS/Wi-Fi offload at the same time is not reasonable.

The idle mode traffic steering/Wi-Fi offload 1207 redirects users to alternative radio layers to balance load on radio or reduce load on transport (in case the alternative radio applies disjoint transport). The real time or active mode TS/Wi-Fi offload actions may be triggered for individual UEs. Thus they provide dedicated actions whereas the idle mode TS operates on camping UEs thus it is a non-deterministic and non-real time action. The multiple variants of the TS/Wi-Fi offload may co-exist in the system.

The real time TS may execute traffic steering or offload while UE has active connections and ongoing data transfer. The smooth execution of the real time TS requires that UE supports MP-TCP, i.e. it is able to virtually split the TCP connection (end-to-end UE—server communication) over multiple RATs and receive data simultaneously via multiple RATs in the same connection. In that case, the MP-TCP connection may be migrated from one RAT to another by first switching on the target RAT and then switching off the source RAT. The real time TS may be triggered per UE or per a set of UEs, to control radio or transport congestion by being able to utilize the alternative RAT/transport resources.

The active mode traffic steering triggers the TS action in case the radio bearer of UE is still established but the applications are currently idle, i.e. there is no ongoing data transfer. The applicability is the same as that of the real time TS, however there is no need for UE side support (on the other hand, the active mode traffic steering has higher latency and more intrusive as the connectivity is fully broken until the re-establishment is completed).

The idle mode traffic steering impacts the RAT/cell selection of camping UEs, i.e. those that have no established radio bearers. This is to balance the load among RATs according to policy/load/radio channel measurement based criteria. Thus the idle mode traffic steering is not applicable in case of congestion, it is non-deterministic and it has to be harmonized with the QoE management to prevent counter-actions. The central QoE orchestrator prohibits TS or Wi-Fi offload to cell/Wi-Fi AP for which overload is detected or to those resources that are in permanent overload/congestion.

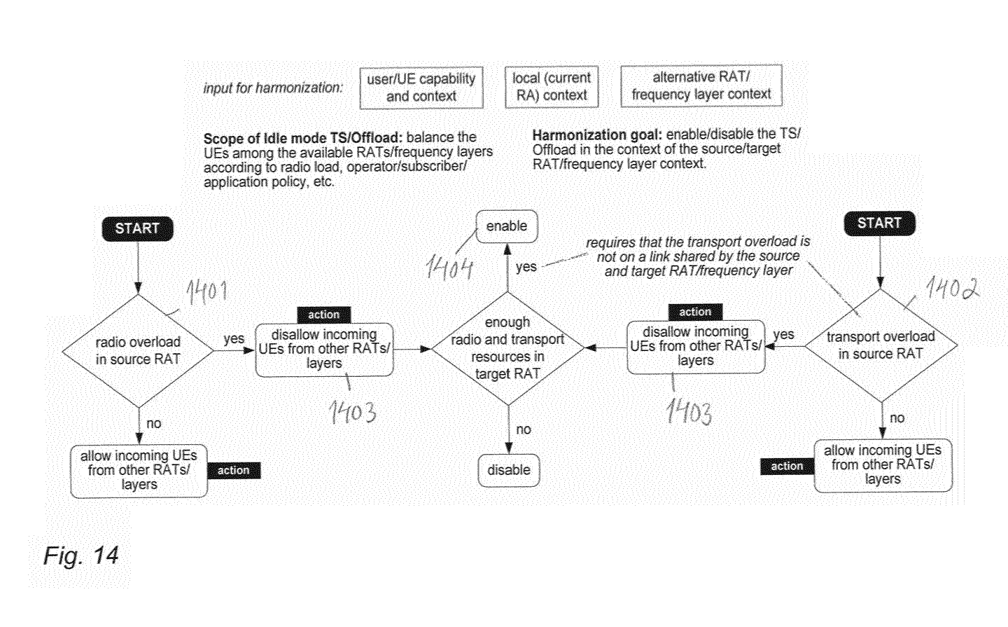

The idle mode traffic steering is harmonized with the QoE management. FIG. 14 illustrates the harmonization of the idle mode traffic steering with idle mode TS/Wi-Fi offload. The harmonization is to prevent TS from steering UEs to congested resources. Note that the congestion may be on the radio side 1401 or at the transport network 1402 serving the target RAT; in either case, TS is blocked 1403 from advocating the usage of the target RAT. The traffic steering in the other direction, however, i.e. steering from congested cells/RATs to those having sufficient resources, is enabled 1404.

In an embodiment, a QoE management entity QME monitors data traffic to detect the applications sessions, derive their resource requirement and perform QoE measurements. Additionally, QME monitors the network status to detect and localize congestion in the end-to-end path and detect the set of applications competing for the same resources. Using this correlated insight, QME initiates proactive or reactive actions to prevent or resolve QoE degradations in the network. QME aligns the QoS profile of the bearers or applications with their resource requirement even in case there is no congestion or QoE degradation, to keep the resource distribution scheme in the system close to optimal from QoE point of view. This ensures that in case congestion does happen, the degree of interaction required for QoE enforcement remains limited, large transients may be avoided and the applications receive as smooth and predictable service as possible even in case their allocated resources are decreased. QME interfaces with the PCC system to utilize the existing PCRF/PCEF functions for executing the actions, and also to harmonize its decisions with the PCC/QoS rules.

In an embodiment, a standardized Gxx interface is used to integrate QME with PCRF/PCEF based enforcement mechanisms already deployed in the mobile system. QME interfaces with the existing PCC infrastructure in order to harmonize its operation with the existing policies and also to implement non-existing QoE driven dynamic traffic management actions partly reusing the existing network functionalities through interfaces such as Gxx and optionally Sd. The Gxx interface may be used a) for obtaining information about the PCC and QoS rules being provisioned by the PCRF in the PCEF, and b) for pushing additional enforcement actions to PCEF through PCRF. The Gxx interface is utilized by masking the enforcement actions as UE initiated QoS modification requests. This makes the integration between QME and PCRF a vendor independent solution in case the PCRF implements the standardized Gxx interface. QME may also implement the Sd interface to provide additional QoE/application specific triggers towards PCRF. This enables shifting logic into an advanced PCRF implementation that is able to act upon application specific events, QoE degradation etc., and receive the required information/triggers from QME.

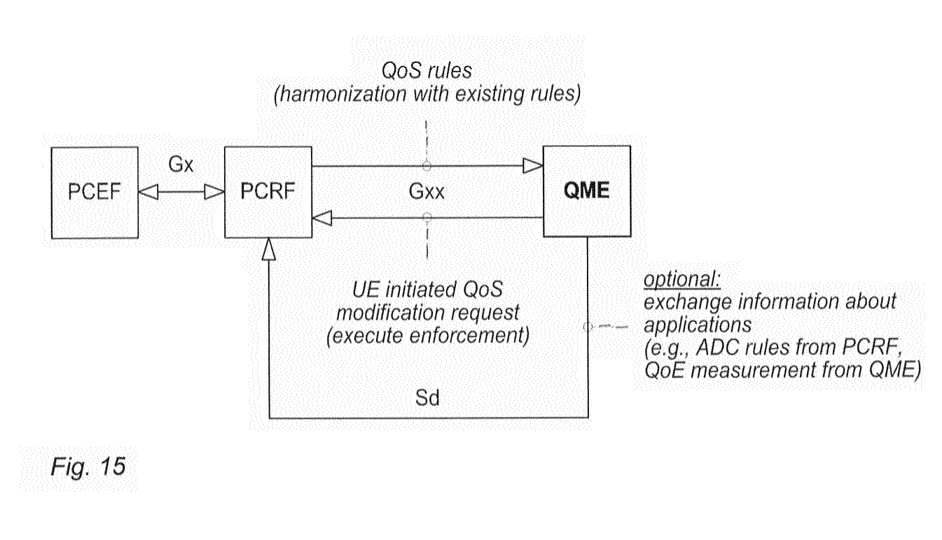

FIG. 15 illustrates logical integration of a third party entity with PCRF/PCEF for QoS/QoE management. Central harmonized QoS/QoE management is implemented in case a PCRF/PCEF based enforcement mechanism is already deployed in the network. Reusing PCEF as the enforcement point protects existing infrastructure investments. By allowing a third party QME to dynamically control PCEF, it is possible to manage the application sessions in real time, in a user, application session, QoE and network status aware way, which is not possible based on the capabilities of PCRF/PCEF only. The decisions of QME take into account the traffic treatment applied by PCRF/PCEF independently based on legacy PCC/QoS rules, creating a harmonized traffic management solution preventing inefficient or contradictory actions originated by PCRF and QME.

QME monitors user plane packets in order to detect applications, measure their QoE, collect application metadata and recognize user actions. When a new application session starts, QME detects its resource requirements and evaluates whether the PCC rules limit the traffic to the extent that prevents good QoE in the first place. In case the PCC rules are a limiting factor (e.g. MBR of the bearer established by UE is lower than the bandwidth requirement of the application session), QME may terminate the session or trigger content adaptation. Otherwise, QME may dynamically select a QoS profile that suits the need of the applications best, to harmonize the network mechanism with the applications. User plane packet monitoring is also an efficient and sensitive way to detect and localize network side congestion. In case there is congestion, QME measures the available resources in the congested network segment and identifies the impacted users, i.e. those that are competing for the same bottleneck resources. Based on the active application sessions, their resource needs, operator policies and priorities, subscription profiles, etc., QME defines how the resources are to be redistributed, i.e. what are the resources that individual application sessions or set of applications receive. The granularity of the application differentiation and resource allocation may target individual application sessions (e.g. a specific video download) and/or aggregates of applications (e.g. calculating and enforcing a cumulative bandwidth for bulk downloads). QME decides about the actions that enforce the proper treatment (e.g. prioritize important traffic, shape down non-interactive background traffic, etc.) in order to provide good QoE for the maximum number of users (or, in case of heavy congestion, to the users that have the highest priority from the operator's point of view). QME uses the Gxx interface in order to send commands (e.g. QCI change/bearer modification, bandwidth limitation, etc.) to PCRF which propagates them further to PCEF. The Gxx interface is also used in QME to get information on the enforcement performed by PCEF based on rules provisioned by PCRF itself.

The Gxx interface has two variants, depending on whether it is terminated by SGW or by another trusted AGW in the network. The SGW variant is referred to as the Gxc interface and the AGW variant is referred to as the Gxa interface. In case of QME integration, the usage of the Gxa or Gxc interfaces depends on the deployment and implementation of QME.

QME may be an in-line network element directly obtaining its user, application and QoE insight from user plane packet monitoring in the core network (see FIG. 15). Alternatively, QME may be a centralized entity that collects the insight via separate monitoring entities, sniffers, or probes deployed in the core network, in the radio access or on any other user plane or control plane interface. In both cases, the integration with PCRF uses the Gxa interface.

When PMIP is used over the S5/S8 interfaces, Gxc is used between PCRF and BBERF located in the SGW to enforce QoS in the radio access network. In this case, QME may be located between PCRF and SGW acting as BBERF towards PCRF and acting as PCRF towards SGW.

Alternatively, QME may also be integrated with SGW itself, in which case the integration with PCRF uses the Gxc interface. This is possible both when GTP and when lo PMIP is used over S5.

In an embodiment, a QoE management action may be masked as a terminal device initiated QoS modification request, in order to enforce QoE of the application session. Thus QME may be able to trigger QoS modification masked as if it was originated from UE. In that case, controlling PCEF requires that QME submits its commands as UE-initiated QoS modification requests to PCRF, wherein the QoS modification requests are implemented as credit control requests (CCR) that are either add new rules or modify or delete existing ones. CCR includes the definition of IP flows which are in the scope of the enforcement, along with the corresponding QoS options. This requires the creation of CCRs with the following attributes: CC-Request-Type AVP is set to “UPDATE_REQUEST”; event-trigger AVP is set to “RESOURCE_MODIFICATION_REQUEST”; packet-filter-operation AVP is set to “ADDITION”, “MODIFICATION” or “DELETION”; packet-filter-information AVP defines the traffic (via IP filters) to which the enforcement applies; QoS-information AVP is set to indicate the requested QoS.

The packet filter information defines the granularity of the enforcement that is available to QME. The packet filters may be created per IP flow, which includes the protocol, the source and destination IP addresses (optionally masked) and source and destination port numbers (or ranges). This information may be obtained and filled by QME based its monitoring of the user plane packet headers.

The possible enforcement actions available for QME are defined by the possible set of supported QoS information. The QoS information may include one or more of the following: QCI of the corresponding bearer; setting guaranteed data rate in DL or in UL; setting maximum data rate in DL or in UL; additionally, it is possible to set the minimum required bandwidth which is used by PCRF to automatically derive the authorized guaranteed data rate and the maximum authorized data rate parameters.

The Gxx interface is also used to obtain information about the QoS rules that PCRF manages independently from QME. PCRF may send the QoS rules in a re-authentication request (RAR) message on the Gxx interface within either the QoS-rule-install AVP or the QoS-rule-remove AVP. QME replies with a re-authentication answer (RAA) accepting activation or removal of the QoS rule.

An alternative way to obtain QoS rules managed independently by PCRF is to deploy a diameter routing agent (DRA) on the Gx interface that forwards the Gx traffic to QME. This provides an insight to the QoS rules transparently to PCRF. In that case, the Gxx interface is used only as a unidirectional interface to propagate the QoS rules to the PCRF.

Optionally, the Sd interface may also be used between PCRF and QME, wherein QME also acts as TDF. QME may receive ADC rules directly from PCRF. These rules indicate the set of applications that may be differentiated using dedicated PCC rules in the existing PCEF and require information to be reported by QME. QME may perform only standard TDF reporting functionality (e.g. identify application sessions, detect and indicate the start and end of application sessions) or it may provide an extended non-standardized set of data (e.g. QoE of the applications, congestion indication, etc.). Receiving the extended measurements requires either Sd interface standardization or proprietary support from PCRF.

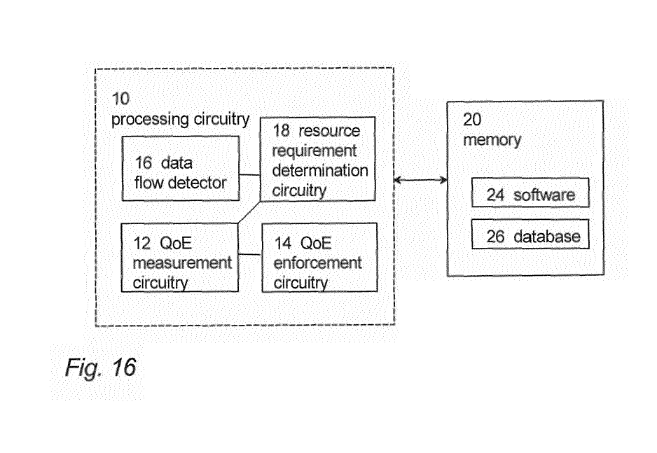

An embodiment provides an apparatus comprising at least one processor and at least one memory including a computer program code, wherein the at least one memory and the computer program code are configured, with the at least one processor, to cause the apparatus to carry out the procedures of the above-described network element or the network node. The at least one processor, the at least one memory, and the computer program code may thus be considered as an embodiment of means for executing the above-described procedures of the network element or the network node. FIG. 16 illustrates a block diagram of a structure of such an apparatus. The apparatus may be comprised in the network element or in the network node, e.g. the apparatus may form a chipset or a circuitry in the network element or in the network node. In some embodiments, the apparatus is the network element or the network node. The apparatus comprises a processing circuitry 10 comprising the at least one processor. The processing circuitry 10 may comprise a data flow detector 16 configured to monitor data traffic and detect a data flow related to an application session. The data flow detector 16 may be configured to detect the data flow related to the application session, as described above, and output information on the data flow and the application session to a resource requirement determination circuitry 18. The resource requirement determination circuitry 18 is configured to define a required QoE level regarding the application session. The apparatus may further comprise a QoE measurement circuitry 12 configured to perform QoE measurements to obtain information QoE experienced by the terminal device regarding the application session. The QoE measurement circuitry may be configured to measure QoE experienced by the terminal device, as described above, and output information on QoE experienced by the terminal device to a QoE enforcing circuitry 14. The QoE enforcing circuitry 14 is configured to execute one or more actions in order to enforce the quality of experience QoE of the application session to meet the resource requirement.

The processing circuitry 10 may comprise the circuitries 12 to 18 as sub-circuitries, or they may be considered as computer program modules executed by the same physical processing circuitry. The memory 20 may store one or more computer program products 24 comprising program instructions that specify the operation of the circuitries 12 to 18. The memory 20 may fur-their store a database 26 comprising definitions for central QoE orchestration, for example. The apparatus may further comprise a communication interface (not shown in FIG. 16) providing the apparatus with radio communication capability with the terminal devices. The communication interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the communication interface may be connected to a remote radio head comprising at least an antenna and, in some embodiments, radio frequency signal processing in a remote location with respect to the base station. In such embodiments, the communication interface may carry out only some of radio frequency signal processing or no radio frequency signal processing at all. The connection between the communication interface and the remote radio head may be an analogue connection or a digital connection. In some embodiments, the communication interface may comprise a fixed communication circuitry enabling wired communications.

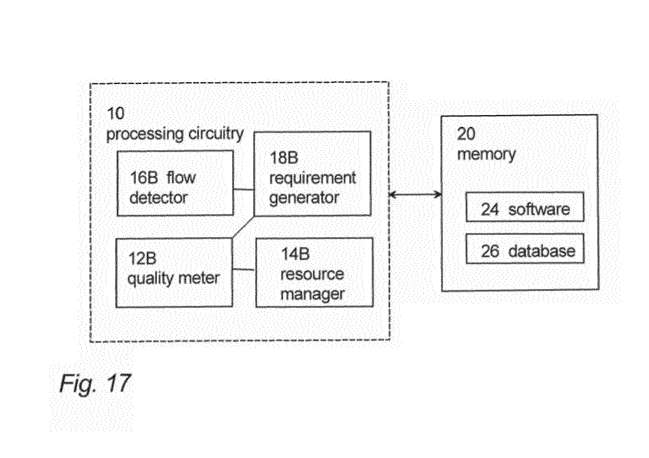

Another embodiment provides an apparatus comprising at least one processor and at least one memory including a computer program code, wherein the at least one memory and the computer program code are configured, with the at least one processor, to cause the apparatus to carry out the procedures of the above-described network element or the network node. The at least one processor, the at least one memory, and the computer program code may thus be considered as an embodiment of means for executing the above-described procedures of the network element or the network node. FIG. 17 illustrates a block diagram of a structure of such an apparatus. The apparatus may be comprised the network element or in the network node, e.g. the apparatus may form a chipset or a circuitry the network element or in the network node. In some embodiments, the apparatus is the network element or the network node. The apparatus comprises a processing circuitry 10 comprising the at least one processor. The processing circuitry 10 may comprise a flow detector 17B configured to monitor data traffic and detect a data flow related to an application session. The flow detector 17B may be configured to detect the data flow related to the application session, as described above, and output information on the data flow and the application session to a requirement generator 18B. The requirement generator 18B is configured to define a required QoE level regarding the application session. The apparatus may further comprise a quality meter 12B configured to perform QoE measurements to obtain information QoE experienced by the terminal device regarding the application session. The quality meter 12B may be configured to measure QoE experienced by the terminal device, as described above, and output information on QoE experienced by the terminal device to a resource manager 14B. The resource manager 14B is configured to execute one or more actions in order to enforce the quality of experience QoE of the application session to meet the resource requirement.

The processing circuitry 10 may comprise the circuitries 12B to 18B as sub-circuitries, or they may be considered as computer program modules executed by the same physical processing circuitry. The memory 20 may store one or more computer program products 24 comprising program instructions that specify the operation of the circuitries 12B to 18B. The memory 20 may fur-their store a database 26 comprising definitions for central QoE orchestration, for example. The apparatus may further comprise a communication interface (not shown in FIG. 17) providing the apparatus with radio communication capability with the terminal devices. The communication interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the communication interface may be connected to a remote radio head comprising at least an antenna and, in some embodiments, radio frequency signal processing in a remote location with respect to the base station. In such embodiments, the communication interface may carry out only some of radio frequency signal processing or no radio frequency signal processing at all. The connection between the communication interface and the remote radio head may be an analogue connection or a digital connection. In some embodiments, the communication interface may comprise a fixed communication circuitry enabling wired communications.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 1 to 17 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

ACK acknowledgement

AP access point

APN access point name

AWND advertised window

BS, BTS base station

BW bandwidth

CoDel controlled delay

DNS domain name system

DSCP differentiated services code point

eNB evolved node-B

GTP general packet radio service tunnelling protocol

HSPA high speed packet access

HSS home subscriber service

HTTP hypertext transfer protocol

IMSI international mobile subscriber identity

IP internet protocol

LTE long term evolution

MME mobility management entity

MP-TCP multipath TCP

OTT over the top

PCC policy and charging control

QCI QoS class index

QoE quality of experience

QoS quality of service

RAT radio access technology

RED random early detection

RFSP RAT/frequency selection priority

SAE-GW service architecture evolution gateway

SF scaling factor

SPI scheduling priority index

SSL secure socket layer

TCP transmission control protocol

TEID tunnel endpoint identity

TLS transport layer security

TS traffic steering

UDP user datagram protocol

UE user equipment

WCDMA wideband code division multiple access

PGW PDN gateway

PDN packet data network

PCEF policy and charging enforcement function

PCRF policy and charging rules function

Wi-Fi wireless fidelity

RADIUS remote authentication dial in user service

RAN radio access network

AVP attribute-value pair

KPI key performance indicator

RNC radio network controller

RAGS resource and admission control subsystem

OFCS off-line charging system

ANDSF access network discovery and selection function

SADM serve-at-once device manager

WAM Wi-Fi activation manager

WSM Wi-Fi system/service manager

SGW serving gateway

1. A method comprising:
monitoring, in a network node, data traffic related to a terminal device of a communication system, in order to detect a data flow related to an application session;
defining, in the network node, resource requirement information defining a required quality of experience QoE level to be provided to the terminal device regarding the application session;
monitoring, in the network node, network status in order to obtain information on the status of available network resources;
performing, in the network node, quality of experience QoE measurements to obtain information on quality of experience QoE experienced by the terminal device regarding the application session;
based on the quality of experience QoE measurements and the status of available network resources, executing, in the network node, one or more actions in order to enforce the quality of experience QoE of the application session to meet the resource requirement.

2. A method of claim 1, wherein said one or more actions comprise a quality of experience QoE management action such as a traffic management/QoE enforcement and/or a resource redistribution action.

3. (canceled)

4. A method of claim 1, the method comprising, in the network node,
checking if there is congestion in a data flow path, wherein if there is, the method comprises
localizing the congestion; and
detecting a set of applications competing for the same resources.

5. A method of claim 1, the method comprising performing, in the network node, quality of experience QoE management in order to prevent existing network mechanisms from counteracting against quality of experience QoE targets of the application session.

6. A method of claim 1, the method comprising, in the network node, performing proactive load throttling by reducing the load generated by TCP sources if overload or an increasing load trend is detected.

7. A method of claim 1, the method comprising, in the network node, optimizing TCP throughput and sender behaviour by adjusting TCP segment pacing to a shaping rate defined by a quality of experience QoE enforcement action.

8. A method of claim 1, the method comprising, in the network node, performing traffic steering and/or Wi-Fi offload by redirecting terminal devices to alternative radio layers or alternative radio access technologies in order to balance the load on the radio resources or reduce the load on a transport network.

9-14. (canceled)

15. An apparatus comprising:
at least one processor; and
at least one memory including a computer program code, wherein the at least one memory and the computer program code are configured, with the at least one processor, to cause the apparatus to
monitor data traffic related to a terminal device of a communication system, in order to detect a data flow related to an application session;
define resource requirement information defining a required quality of experience QoE level to be provided to the terminal device regarding the application session;
monitor network status in order to obtain information on the status of available network resources;
perform quality of experience QoE measurements to obtain information on quality of experience QoE experienced by the terminal device regarding the application session;
based on the quality of experience QoE measurements and the status of available network resources, execute one or more actions in order to enforce the quality of experience QoE of the application session to meet the resource requirement.

16. An apparatus of claim 15, wherein said one or more actions comprise a quality of experience QoE management action such as a traffic management/QoE enforcement and/or a resource redistribution action.

17. (canceled)

18. An apparatus of claim 15, wherein the at least one memory and the computer program code are configured, with the at least one processor, to cause the apparatus to
check if there is congestion in a data flow path, and if there is,
localize the congestion, and detect a set of applications competing for the same resources.

19. An apparatus of claim 15, wherein the at least one memory and the computer program code are configured, with the at least one processor, to cause the apparatus to perform quality of experience QoE management in order to prevent existing network mechanisms from counteracting against quality of experience QoE targets of the application session.

20. An apparatus of claim 15, wherein the at least one memory and the computer program code are configured, with the at least one processor, to cause the apparatus to perform proactive load throttling by reducing the load generated by TCP sources if overload or an increasing load trend is detected.

21. An apparatus of claim 15, wherein the at least one memory and the computer program code are configured, with the at least one processor, to cause the apparatus to optimize TCP throughput and sender behaviour by adjusting TCP segment pacing to a shaping rate defined by a quality of experience QoE enforcement action.

22. An apparatus of claim 15, wherein the at least one memory and the computer program code are configured, with the at least one processor, to cause the apparatus to perform traffic steering and/or Wi-Fi offload by redirecting terminal devices to alternative radio layers or alternative radio access technologies in order to balance the load on the radio resources or reduce the load on a transport network.

23. An apparatus of claim 15, wherein the at least one memory and the computer program code are configured, with the at least one processor, to cause the apparatus to perform connection termination or connection throttling of the application session in case a predetermined congestion criteria is fulfilled.

24. An apparatus of claim 15, wherein the at least one memory and the computer program code are configured, with the at least one processor, to cause the apparatus to perform quality of experience QoE enforcement by enforcing a maximum data rate for the data traffic by delaying excess data in a packet buffer, wherein the data rate is defined based on the resource requirement of the application session.

25. An apparatus of claim 15, wherein the at least one memory and the computer program code are configured, with the at least one processor, to cause the apparatus to perform quality of experience QoE enforcement by prioritizing a data flow or an application session over another.

26-29. (Cancelled)

30. An apparatus comprising:
a flow detector configured to monitor data traffic related to a terminal device of a communication system, in order to detect a data flow related to an application session;
a requirement generator configured to define resource requirement information defining a required quality of experience QoE level to be provided to the terminal device regarding the application session;
a circuitry configured to monitor network status in order to obtain information on the status of available network resources;
a quality meter configured to perform quality of experience QoE measurements to obtain information on quality of experience QoE experienced by the terminal device regarding the application session;
a resource manager configured to, based on the quality of experience QoE measurements the status of available network resources, execute one or more actions in order to enforce the quality of experience QoE of the application session to meet the resource requirement.

31. (canceled)

32. A computer program product embodied on a non-transitory distribution medium readable by a computer and comprising program instructions which, when loaded into the computer, execute a computer process comprising causing a network node to
monitor data traffic related to a terminal device of a communication system, in order to detect a data flow related to an application session;
define resource requirement information defining a required quality of experience QoE level to be provided to the terminal device regarding the application session;
monitor network status in order to obtain information on the status of available network resources;
perform quality of experience QoE measurements to obtain information on quality of experience QoE experienced by the terminal device regarding the application session;
based on the quality of experience QoE measurements and the status of available network resources, execute one or more actions in order to enforce the quality of experience QoE of the application session to meet the resource requirement.

33. An apparatus of claim 15, wherein the at least one memory and the computer program code are configured, with the at least one processor, to cause the apparatus to define required quality of experience QoE level to be provided to the terminal device regarding the application session based on individual needs of each application, per user/application policies and policy and charging control/quality of service rules and network status.
